(19) United States
(12) Patent Application Publication
(10) Pub. No.: US 2025/0263632 A1
(43) Pub. Date: Aug. 21, 2025

(54) PROCESS FOR SOLVENT RECOVERY IN VEGETABLE OIL EXTRACTION

(71) Applicant: CARGILL, INCORPORATED, Wayzata, MN (US)

(72) Inventors: Hendrik Jan BEUKERS, Hoogland (NL); Michele MARAZZATO, Rotterdam (NL); Maria Christina STEVERINK-DE ZOETE, Den Haag (NL)

(21) Appl. No.: 18/857,247

(22) PCT Filed: Apr. 5, 2023
(86) PCT No.: PCT/US2023/017517

§ 371 Date: Oct. 16, 2024

(30) Foreign Application Priority Data
Apr. 19, 2022 (EP) 22168809.6
Jun. 30, 2022 (EP) 22182125.9

(51) Int. Cl. C11C 1/00; B01D 53/14

(52) U.S. Cl. CPC C11C 1/007; B01D 53/1487; B01D 53/1493; B01D 2252/20; B01D 2257/702; B01D 2258/0275

(57) ABSTRACT

Present invention relates to a method for recovering solvent from an effluent gas comprising the steps of a) providing effluent gas from a solvent extraction system wherein oil is extracted from oil-containing organic material; b) absorbing solvent from the effluent gas using a medium-chain triglyceride (MCT) oil to absorb the solvent; c) stripping solvent from the MCT oil from step b); and d) reuse of the recovered MCT oil from step c) for absorbing solvent. The invention also relates to a process for extracting oil from oil-containing organic material by means of solvent, whereby the process is comprising the method for recovering solvent from an effluent gas by means of an MCT oil. Finally, the invention relates to the use of MCT oil as absorber oil for recovering solvent from an effluent gas.

### CROSS-REFERENCE TO RELATED APPLICATIONS

This application claims the benefit of European Application No. 22168809.6, filed Apr. 19, 2022 and European Application No. 22182125.9, filed Jun. 30, 2022, each of which is incorporated by reference herein in its entirety.

### FIELD OF THE INVENTION

The present invention relates to a process for recovering solvent from solvent-containing effluent gasses, preferably generated in solvent extraction systems used to extract oil from oil-containing organic material. The invention further relates to a process for solvent extraction of oil-containing organic material and the use of MCT oil as absorbent oil in solvent recovery systems.

### BACKGROUND OF THE INVENTION

Mineral Oil Hydrocarbons (MOH) may be present as contaminants in oils and fats as well as in foods prepared thereof. MOH are a complex mixture of molecules that are usually categorized into two main groups: Mineral Oil Saturated Hydrocarbons (MOSH) and Mineral Oil Aromatic Hydrocarbons (MOAH). MOSH are linear and branched (cyclo)alkanes. MOAH consists of highly alkylated mono/polycyclic aromatic hydrocarbons.

Contamination of food and feed products with MOH may occur through migration from materials in contact with food such as plastic materials, like polypropylene or polyethylene, recycled cardboard and jute bags. Contamination also occurs from the use of mineral oil-based food additives or processing aids and from unintentional contamination like for example from lubricants or exhaust gases from combustion engines.

From a health perspective, it is desirable to reduce contamination of vegetable oils with MOH during their processing.

A potential source of MOH contamination of organic material is occurring during solvent extraction of the oil from the organic material. Solvent extraction technology nowadays recovers almost all the solvent used in the extraction process and recirculate this solvent into the process. Mineral oil is commonly used in this solvent recovery step for recovering solvent from the effluent gasses from the extraction process. As a result, this process step is a potential source of contamination of the organic material or more specifically the oil extracted from it with MOH.

There is thus a need in the industry for an improved method for solvent recovery without using a potential source for MOH contamination in organic material and more specifically the oil extracted from it. The present invention provides such a process.

### SUMMARY OF THE INVENTION

The present invention relates to a method for recovering solvent from an effluent gas, and the method is comprising the steps of:
a) providing an effluent gas from a solvent extraction system wherein oil is extracted from oil-containing organic material;
b) absorbing solvent from the effluent gas using a medium-chain triglyceride (MCT) oil to absorb the solvent;
c) stripping solvent from the MCT oil from step b); and
d) reuse of the recovered MCT oil from step c) for absorbing solvent.

The present invention also relates to a process for extracting oil from oil-containing organic material by means of solvent, and the process is comprising the steps of:
i) Extracting oil-containing organic material with solvent and obtaining a miscella stream, a stream of solvent-wet residual solids, and a first effluent gas stream;
ii) Recovering solvent from the solvent-wet residual solids stream from step i) and obtaining a second recovered solvent stream, a desolventized residual solids stream and a second effluent gas stream;
iii) Separating the miscella stream from step i) into a first recovered solvent stream, extracted oil and a third effluent gas stream;
iv) Recovering solvent from an effluent gas stream comprising the first effluent gas stream from step i), the second effluent gas stream from step ii), the third effluent gas stream from step iii), or a combination of two or more thereof, wherein the solvent recovering step is comprising the method for recovering solvent from an effluent gas according to the present invention, and obtaining a third recovered solvent steam and an exit gas; and
v) Reuse of a recovered solvent stream comprising the first recovered solvent stream from step i), the second recovered solvent stream from step ii) and/or the third recovered solvent stream from step iv) for extraction of oil from oil-containing organic material.

The present invention further relates to the use of MCT oil as absorber oil for recovering solvent from an effluent gas.

### BRIEF DESCRIPTION OF THE DRAWINGS

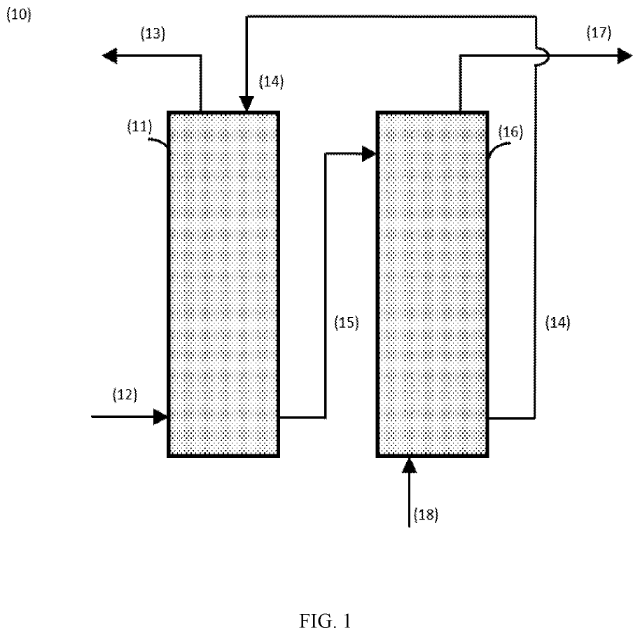

FIG. 1: is one example of the method for recovering solvent from an effluent gas of a solvent extraction system for vegetable oil extraction in accordance with the teachings of the present invention:
(10)=Solvent absorption system;
(11)=Absorption column;
(12)=Effluent gas;
(13)=Exit gas;
(14)=solvent-lean MCT oil
(15)=Solvent-rich MCT oil;
(16)=Stripping column;
(17)=Recovered solvent stream;
(18)=Stripping agent

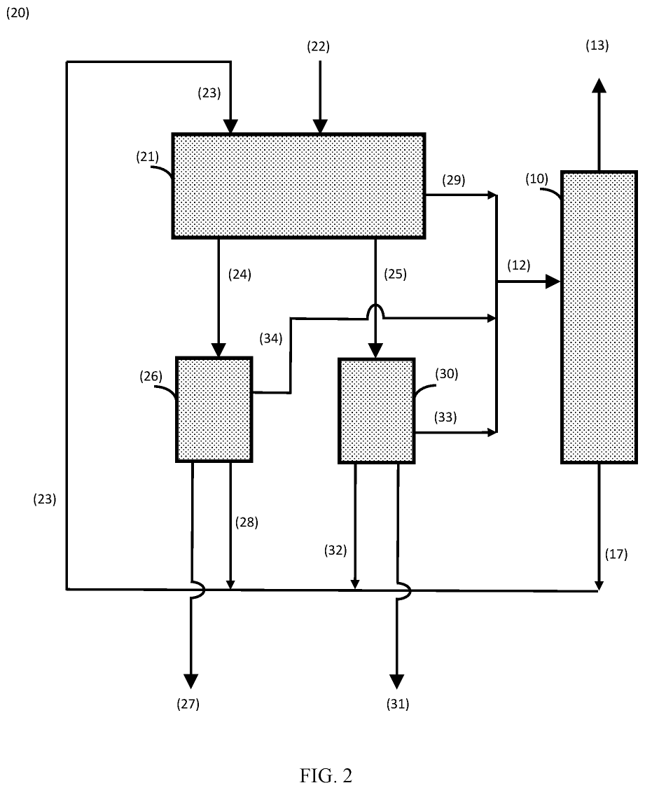

FIG. 2: is an example of the process for extracting oil from oil-containing organic material by means of solvent in accordance with the teachings of the present invention:
(10)=solvent absorption system;
(12)=effluent gas comprising the first effluent gas stream (29) and/or the second effluent gas stream (33);
(13)=exit gas;
(17)=third recovered solvent stream;
(20)=solvent extraction system;
(21)=Extractor unit;
(22)=oil-containing organic material;
(23)=solvent comprising the first recovered solvent stream (28), the second recovered solvent stream (32) and/or the third recovered solvent stream (17);
(24)=miscella stream
(25)=solvent-wet residual solids
(26)=solvent recovery unit;
(27)=extracted oil stream;
(28)=first recovered solvent stream;
(29)=first effluent gas stream;
(30)=desolventizing unit;
(31)=desolventized residual solids;
(32)=second recovered solvent stream;
(33)=second effluent gas stream
(34)=third effluent gas stream.

### DETAILED DESCRIPTION

### Method for Solvent Recovery From the Effluent Gasses

The present invention relates a method for recovering solvent from an effluent gas, and the method is comprising the steps of:
a) providing an effluent gas from a solvent extraction system wherein oil is extracted from oil-containing organic material;
b) absorbing solvent from the effluent gas using a medium-chain triglyceride (MCT) oil to absorb the solvent;
c) stripping solvent from the MCT oil from step b); and
d) reuse of the recovered MCT oil from step c) for absorbing solvent.

### Step a)—Providing Effluent Gas From a Solvent Extraction System

The method according to the present invention for recovering solvent from an effluent gas, may be part of a solvent extraction system wherein oil is extracted from oil-containing organic material. “Organic material” refers to any carbon-based compounds, derived from living organisms as well as their lab-synthesized versions. Oil-containing organic material can be originating from plants, animals and micro-organisms, preferably plant material.

During the solvent extraction process, effluent gasses are generated that contain a residual amount of solvent. An effluent gas may for example originate from steam that is used in the solvent extraction system to vaporize solvent in a distillation column and that is subsequently passed through a condenser to recover condensable liquids and a non-condensable effluent gas. This residual solvent is recovered from the effluent gasses in a solvent absorption system (10) by the method according to the present invention.

The effluent gas (12) that is provided in step a) of the method of the present invention, is typically an effluent gas that has already passed through a condenser unit to remove condensable gasses and/or liquids from the gas stream. The effluent gas (12) that is provided in step a), is a non-condensable effluent gas containing residual solvent. The effluent gas (12) that is provided in step a) may comprise air mixed with residual solvent. The effluent gas (12) may contain solvent in an amount of from 50 to 70 wt. %, from 52 to 68 wt. %, or from 55 to 65 wt. % on total weight of the effluent gas. The solvent present in the effluent gas (12) may be any type of organic solvent such as, but not limited to hexane, acetone, toluene, petroleum ether, diethyl ether, ethanol, n-heptane, isopropanol, acetone, chloroform, methanol, and 1-butanol, terpenes, or any combination of two or more thereof. Typically, the solvent present in the effluent gas may be a commercial grade solvent. Preferably, the solvent present in the effluent gas (12) is comprising hexane. The term “hexane” is encompassing commercial hexane having boiling point in the temperature range of 65-69° C. Most commercial hexane available contains approximately 65% of n-hexane, with the remaining 35% of the composition being cyclopentane and hexane isomers.

The method for recovering solvent from effluent gasses of a solvent extraction system (20) may be applied in combination with any type of solvent extraction system for extracting oil from organic material. The effluent gas (12) that is provided in step a) of the method of the present invention may be effluent gas from one or more solvent extraction systems. The effluent gas (12) may originate from any processing unit of a solvent extraction system (20), such as but not limited to an extractor unit (21), a solvent recovery unit (26) or a desolventizing unit (30) and/or from any leak of air through joints or flanges. In one aspect of the invention, the effluent gas in step a) is provided from the extractor unit (21), from the solvent recovery unit (26) and/or from the de-solventizing unit (30).

### Step b)—Absorbing Solvent From the Effluent Gas Using a MCT Oil

The method for recovering solvent from effluent gasses of a solvent extraction system (20) is performed in a solvent absorption system (10) (see FIG. 1) comprising an absorption column (11) and a stripping column (16).

In step b) of the process according to the present invention, the residual solvent that is present in the effluent gas (12) is absorbed by an MCT oil (14) by contacting the effluent gas (12) with the MCT oil (14) in the absorption column (11). The MCT oil that enters the absorption column (11) is solvent-lean MCT oil (14), containing solvent in an amount of from 0.1 to 0.6 wt. %, 0.2 to 0.5 wt. %, or from 0.3 to 0.4 wt. % on total weight of the solvent-lean MCT oil.

A “medium-chain triglyceride (MCT) oil” in the present invention is encompassing a composition comprising triglycerides, diglycerides, monoglycerides and/or free fatty acid having a carbon chain length in a range of C6 to C12 and the fatty acid moiety from C6 to C12 of the MCT oil has a combined content in an amount of more than 70% on total weight of the fatty acid moiety. In other words, the MCT oil is encompassing a composition comprising triglycerides, diglycerides, monoglycerides and/or free fatty acid, said triglycerides, diglycerides, monoglycerides and/or free fatty acid having a combined content of a fatty acid moiety with a carbon chain length in a range of C6 to C12 in an amount of more than 70% on total weight of the fatty acid moiety. It is clear that the fatty acid moiety is referring to the carbon chain length of the fatty acid, being free or bound, preferably bound.

The fatty acid moiety of the MCT oil in step b) of the method according to the present invention may have a combined content of a fatty acid moiety with a carbon chain length in a range of C6 to C12 of more than 75%, or more than 80 wt. % on total weight of the fatty acid moiety. Preferably, the combined content of fatty acid moiety of C8 and C10 of the MCT oil in step b) of the method according to the present invention is present in an amount of more than 92 wt %, more than 94 wt %, more than 96 wt % on total weight of the fatty acid moiety. More preferably, the content of fatty acid moiety of C8 of the MCT oil in step b) is in a range of from 45 to 70 wt %, from 48 to 67 wt %, or from 50 to 65 wt %; and a content of C10 fatty acid moiety is from 30 to 50 wt %, from 32 to 47 wt %, or from 34 to 45 wt % on total weight of the fatty acid moiety.

Preferably the MCT oil has a combined content of fatty acid moiety having a C8 and C10 chain length, in a range of more than 92 wt %.

The MCT oil may have a free fatty acid content of less than 50 wt. %, less than 40 wt. % or less than 30 wt. % on total weight of the MCT oil. In a preferred aspect of the invention, the MCT oil has a content of free fatty acids of less than 1%, less than 0.7 wt. % or even less than 0.5 wt. % on total weight of the MCT oil.

The MCT oil is a commercially available oil or may be obtained via any process available. Typically, the MCT oil is obtained by randomly interesterifying glycerine and medium-chain fatty acids (MCFA). These medium chain fatty acids are typically sourced from vegetable lauric oils. The term “vegetable lauric oil” is encompassing vegetable oils having a content of C6 to C12 fatty acids of more than 50%. Examples of such a vegetable lauric oil include coconut oil, palm kernel oil, babassu oil, cohune oil, tacum oil and cuphea oil or any mixture of two or more thereof. For the purposes of the present invention, the MCT source will preferably be sourced from coconut oil, palm kernel oil, or mixtures thereof. The medium chain fatty acids may for example be obtained by hydrolysis (splitting) of the lauric vegetable oil followed by a further purification of the medium chain fatty acids, e.g. by distillation.

The effluent gas (12) is contacted with the MCT oil (14) in step b) in an absorption column (11) and the solvent contained in the effluent gas (12) is transferred from the gas phase to the liquid phase of the MCT oil. Absorption columns of any suitable configuration may be used. The MCT oil (14) and the effluent gas (12) may be flowing is co-current, cross-current or counter-current direction through the absorption column (11). Preferably, the MCT oil and the effluent gases are flowing in a counter-current direction through the absorption column (11). The MCT oil (14) is following in a top-to-bottom direction and the effluent gas (12) is flowing in a bottom-to-top direction.

The absorption column (11) may include packing material such as, but not limited to, rachid rings or ceramic sadles, for increasing the intermixing of the MCT oil (14) and the effluent gas (12) and facilitating the transfer of solvent.

Preferably the MCT oil (14) is provided to step b) in the absorption column (11) at a temperature in a range of from 15 to 35° C., from 18 to 32° C., or from 22 to 30° C.

Preferably the effluent gas (12) is provided to step b) in the absorption column (11) at a temperature in a range of from 15 to 35° C., from 18 to 32° C., or from 22 to 30° C.

An exit gas (13) and a solvent-rich MCT oil (15) are obtained from step b) of the method according to the invention. The content of solvent in the exit gas is reduced such that the exit gas (13) may be discharged into the atmosphere. In a preferred aspect of the invention, the solvent content in the exit gas is less than 0.8 wt %, less than 0.5 wt %, or even less than 0.2 wt % on total weight of the exit gas. The solvent-rich MCT oil (15) has a content of solvent in a range of from 1.5 to 3.0 wt. %, from 1.8 to 2.8 wt. %, or from 2.0 to 2.5 wt % on total weight of the solvent-rich MCT oil. The solvent-rich MCT oil (15) is further treated in step c) of the method.

### Step c)—Stripping Solvent From the MCT Oil From Step c)

In step c) of the method according to the present invention, the solvent is removed from the solvent-rich MCT oil (15) that is obtained from step b). Removal of the solvent from the solvent-rich MCT oil (15) may occur in a stripping column or stripping vessel (16) wherein a stripping agent (18), such as steam or nitrogen, will strip the solvent from the MCT oil. As a result of step c) a solvent-lean MCT oil (14) and a recovered solvent stream (17) is obtained. The solvent-lean MCT oil (14) is having a solvent content in a range of from 0.1 to 0.6 wt. %, 0.2 to 0.5 wt. %, or from 0.3 to 0.4 wt. % of solvent on total weight of the recovered MCT oil. The recovered solvent stream (17) may be further sent to a condenser for condensing and further reuse of the recovered solvent in the extraction process.

Removal of the solvent from the solvent-rich MCT oil (15) in step c) may occur at a temperature in a range of from 90 to 130° C., from 100 to 125° C., or from 110 to 120° C. The stripping column or stripping vessel (16) may typically be maintained under 150 to 300 mm Hg absolute pressure.

### Step d)—Reuse of the Recovered MCT Oil From Step c)

In step d) of the method according to the present invention the solvent-lean MCT oil (14) that is obtained from step c) is reused as absorbing solvent. The solvent-lean MCT oil (14) that is obtained from step c) may be recycled within any the absorption system. Preferably the solvent-lean MCT oil (14) that is obtained from step c) is recycled and provided again as the MCT oil in step b) of the method of the present invention.

The MCT oil may be used multiple times in steps b) to d) of the method according to the invention. In one aspect of the invention, the MCT oil may be used more than 5000 times, more than 8000 time, or even more than 10000 times in step b) to d). In principle the MCT oil may be re-circulated in steps b) to d) 5 to 50 times per day, during more than 90 consecutive days, more than 180 days, more than 360 days. In fact, an unending reuse can be foreseen.

The method for solvent recovery from effluent gasses according to the present invention does not make use of mineral oil as absorption oil, which is the case in existing solvent recovery systems. In such existing solvent recovery systems, the mineral oil that is used as absorption oil may cause, indirectly through the recovered solvent, a contamination of the extracted oil with MOH. Instead, the method of the present invention uses MCT oil as absorption oil and thus does not cause any contamination of the extracted oil with MOH.

Alternative, existing processes for solvent recovery from effluent gasses exist that are making use of the vegetable liquid oil from the extraction process as absorption oil. However, such vegetable liquid oils are highly unsaturated and therefore prone to oxidation and polymerization. As a consequence, they are not efficient absorption oils. They can only be recycled as absorber oil for a limited number of cycles. Alternatively, they are not recycled at all, which leads to a reduced capacity and flexibility of the oil extraction process.

The method for recovering solvent from an effluent gas according to the present invention, making use of MCT oil as absorption oil, allows to make use of the same equipment as traditional solvent recovery systems based on mineral oil. There are no adaptations needed to the equipment and the equipment can run with the same efficiency and performance. Moreover a non-ending reuse can be foreseen and the extracted oil is not contaminated with MOH.

In comparison to traditional solvent recovery systems based on mineral oil, the method for recovering solvent from an effluent gas according to the present invention, making use of MCT oil as absorption oil, results in a similar efficiency of hexane recovery, no indication of fouling of absorption column (step b)) or stripping column (step c)), no indication of polymerization, similar consumption of absorption oil over time, similar consumption of hexane over time and similar discoloration of the absorption oil over time.

### Process for Organic Material Oil Extraction

The present invention also relates to a process for extracting oil from oil-containing organic material by means of solvent, and the process is comprising the steps of:
i) Extracting oil-containing organic material with solvent and obtaining a miscella stream, a stream of solvent-wet residual solids, and a first effluent gas stream;
ii) Recovering solvent from the solvent-wet residual solids stream from step i) and obtaining a second recovered solvent stream, a desolventized residual solids stream and a second effluent gas stream;
iii) Separating the miscella stream from step i) into a first recovered solvent stream, extracted oil and a third effluent gas stream;
iv) Recovering solvent from an effluent gas stream comprising the first effluent gas stream from step i), the second effluent gas stream from step ii), the third effluent gas stream from step iii), from any leak of air through joints or flanges, or a combination of two or more thereof, wherein the solvent recovering step is comprising the method for recovering solvent from an effluent gas according to the present invention, and obtaining a third recovered solvent steam and an exit gas; and
v) Reuse of a recovered solvent stream comprising the first recovered solvent stream from step i), the second recovered solvent stream from step ii) and/or the third recovered solvent stream from step iv) for extraction of oil from oil-containing organic material.

The process for solvent-extracting oil from organic material is performed in a solvent extraction system (20) (see FIG. 2), comprising an extractor unit (21), a solvent recovery unit (26), a desolventizing unit (30) and a solvent absorption system (10).

### Step i)—Extracting Oil-Containing Organic Material With Solvent

Step i) of the process is performed in the extractor unit (21). The extractor unit (21) may have any suitable type of extractor design such as, but not limited to, an immersion extractor or a percolation extractor. Typically, the extractor unit (21) is operated such that a stream of solvent (23) and a stream of oil-containing organic material (22) is introduced into the extractor unit (21) and flowing in counter-current directions through the extractor unit.

The oil-containing organic material (22) may be derived from any type of organic material. “Organic material” refers to any carbon-based compounds, derived from living organisms as well as their lab-synthesized versions. Oil-containing organic material be originating from plants, animals and micro-organisms. Oil-containing plant material may be oil-bearing seeds or fruits such as, but not limited to, soybeans, rapeseeds, sunflower seeds, peanuts, cottonseeds, palm kernels, palm fruits, coconuts, com germs and combinations thereof. Preferably, the oil-containing organic material (22) is an oil-containing plant material. More preferably, the oil-containing organic material (22) is derived from seeds selected from the group consisting of soybeans, rapeseeds, sunflower seeds, and any combination of two or more thereof

The oil-containing organic material (22) may be organic-material from which oil was already partially removed by means of mechanical processing. The oil-containing organic material (22) may have been treated prior to step i) in order to facilitate oil release during the solvent extraction process. Examples of such treatment are, but are not limited to cleaning, dehulling, drying, heating, cooking, cracking, flaking, expelling, extruding and the like.

The oil-containing organic material (22) may be extracted in step i) of the process with any suitable type of solvents (23), such as, but not limited to hexane, acetone, toluene, petroleum ether, diethyl ether, ethanol, n-heptane, isopropanol, acetone, chloroform, methanol, and 1-butanol, terpenes, or any combination of two or more thereof. Oil-extraction from oil-containing organic material is commonly performed using commercial-grade solvents. Preferably, the solvent present in the effluent gas (12) is comprising hexane. The solvent is including hexane, cyclohexane, heptane, iso-heptane, cyclopentane, corresponding isomers and mixtures of two or more thereof. The term “hexane” is encompassing commercial hexane having boiling point in the temperature range of 65-69° C. Most commercial hexane available contains approximately 65% of n-hexane, with the remaining 35% of the composition being cyclopentane-and hexane-isomers.

During the extraction process, the concentration of extracted oil in the solvent is increasing. The extraction process results in a miscella stream (24), and a solvent-wet residual solids stream (25), i.e. a stream of residual solids containing solvent. The miscella stream (24) leaving the solvent extractor contains about 70-80 wt. % solvent on total weight of miscella. Furthermore, the extraction process is resulting in a first effluent gas stream (29) that is loaded with solvent. This effluent gas stream (29) can be brought into the solvent absorption system (10).

### Step ii)—Recovering Solvent From the Solvent-Wet Residual Solids Stream From Step i)

In step ii) of the process according to the invention, solvent is recovered from the solvent-wet residual solids stream (25) in the desolventizing unit (30). The temperature of the stream may be increased to a temperature above the boiling point of the solvent, causing residual solvent to vaporize. Temperature of the stream may be increased by any means of direct or indirect heating, such as for example by means of steam injection into desolventizing unit (30). The desolventizing unit (30) may be configured as a conventional desolventizer, using direct and/or indirect steam, a flash desolventizer, a fluid bed desolventizer, or a vacuum desolventizing/stripping unit.

The solvent recovery in step ii) of the process according to the invention results in a de-solventized residual solids stream (31). The de-solventized residual solids stream (31) that is obtained in step ii) of the process according to the invention has a solvent content of less than 2 wt. %, mess than 1 wt. % or even less than 0.5 wt. % of solvent on total weight of the de-solventized residual solids stream. Furthermore, the solvent recovery in step ii) of the process results in a second effluent gas stream (33). This effluent gas stream (33) can be brought into the solvent absorption system (10).

### Step iii)—Separating the Miscella Stream From Step i)

In step iii) of the process according to the invention, solvent is recovered from the miscella stream (24) in the solvent recovery unit (26). The solvent recovery unit (26) may be implemented using one or more distillation columns, stripping columns, and/or evaporator units.

The solvent recovery unit (26) may be effective to remove the solvent from the extracted oil in the miscella stream (24). The extracted oil stream (27) that is obtained in step iii) of the process according to the invention has a solvent content of less than 2 wt. %, less than 1 wt. % or even less than 0.5 wt. % of solvent on total weight of the extracted oil stream. Next to the extracted oil stream (27), a solvent-water vapor is obtained in step iii) that is further condensed. A first recovered solvent stream (28) is obtained and a remaining non-condensable effluent gas (34). Non-condensable effluent gas is a third effluent gas steam (34) that may be further treated in step iv) for removing the remaining solvent.

### Step iv)—Recovering Solvent From an Effluent Gas Stream

In step iv) of the process according to the invention, solvent is recovered from effluent gas streams. The solvent-rich effluent gas streams comprise a first effluent gas stream (29) obtained in step i) of the process, a second effluent gas stream (33) obtained in step ii) of the process, a third effluent gas stream (34) obtained in step iii) of the process, or a combination of 2 or more thereof. Preferably, the solvent-rich effluent gas streams comprise a first effluent gas stream (29) obtained in step i) of the process, a second effluent gas stream (33) obtained in step ii) of the process and a third effluent gas stream (34) obtained in step iii) of the process. The solvent recovering step is comprising the method for recovering solvent from an effluent gas according to the present invention. Typically, the solvent recovering step is further comprising a step of condensing in a condenser the effluent gas prior to the method for recovering solvent from the effluent gas. The use of the condenser allows to remove condensable gases and/or liquids from the effluent gas stream. As a result, the effluent gas being processed by the method of the present invention may be a cooled, non-condensable effluent gas.

The solvent recovery in step iv) of the process according to the invention results an exit gas (13) that may be discharged into the atmosphere. The solvent content in the exit gas is less than 0.8 wt %, less than 0.5 wt %, or even less than 0.2 wt % on total weight of the exit gas.

### Step v)—Reuse of a Recovered Solvent Stream

In step v) of the process according to the invention, a recovered solvent stream is reused for extraction of oil from oil-containing organic material (22). The recovered solvent stream (23) is comprising the first recovered solvent stream (28) from step iii), second recovered solvent stream (32) from step ii) and/or a third recovered solvent stream (17) from step iv). Preferably, the recovered solvent stream (23) is comprising the first recovered solvent stream (28) from step iii), second recovered solvent stream (32) from step ii) and a third recovered solvent stream (17) from step iv). The recovered solvent stream (23) may be recycled within any oil extraction process. Typically, water that may be present in the recovered solvent stream is removed prior to the recycling of the solvent. Solvent-water separation may occur by means of any suitable process such as, for example in a decanting tank wherein the solvent that is immiscible with water is separated based on their difference in gravity. Preferably, recovered solvent stream (23) is recycled within the extraction process and is provided again as the solvent (23) in step a) of the method.

The extraction process according to the present invention is highly efficient in terms of solvent recovery and reuse. Additionally, by using the method for solvent recovery from effluent gasses according to the present invention, and thus by making use of MCT oil instead of mineral oil as absorber oil, the extraction process according to the invention does not result in a contamination of the extracted oil with MOH.

Alternative processes exist wherein extracted liquid oils are used as absorber oil. However, such processes are less efficient since the liquid oil cannot be recycled as frequent as the MCT oil due to their high instability in terms of oxidation and polymerization. Existing processes are even not recycling the extracted liquid oil that is serving as absorbent oil. As a result, such processes are not flexible and do not allow easy switching of seed oil type. Additionally, it requires an increased distillation capacity to in order to completely remove the solvent from the absorber oil before it is added back to the rest of the extracted liquid oil.

### Use of MCT Oil as Absorber Oil

Finally, the present invention also relates the use of MCT oil as absorber oil for recovering solvent from an effluent gas of a solvent extraction system for vegetable oil extraction. It relates to the use of MCT oil as absorber oil for recovering solvent from an effluent gas, wherein the solvent is comprising hexane.

It further relates to the use wherein the effluent gas is from a solvent extraction system wherein oil is extracted from oil-containing organic material.

### EXAMPLE

### Test Set-Up

Crude sunflower oil was extracted from sunflower seeds at crushing facility in France.

Prior to oil extraction the seeds were cleaned, dried and conditioned.

Oil extraction was subsequently performed by a combination of mechanical pressing of the seeds into sunflower oil and partially de-oiled sunflower cake, followed by extraction of the remaining oil from the cake by means of solvent.

Solvent extraction of the sunflower cake was performed in equipment that is commonly known, comprising an extractor unit (21), a desolventising unit (30), a solvent recovery unit (26), a solvent absorption system (10) for recovering solvent from the effluent streams and a solvent storage unit.

Step i): In the extractor unit (21), the partially de-oiled sunflower cake (22) was extracted with hexane. A mixture of hexane/sunflower oil (miscella stream (24)) was obtained and a stream of hexane-wet sunflower meal (25). The effluent gasses from the solvent extraction unit containing hexane were captured (29).

Step ii); In the desolventizing unit (30), the hexane was evaporated from the hexane-wet meal (25) that was obtained from step i). A desolventized sunflower meal (31) is obtained and a mixture of hexane and water vapor (32). The effluent gasses from the desolventizing unit containing hexane were captured (33).

Step iii): In the solvent recovery unit (26), the miscella stream (24) is separated into a stream of extracted sunflower oil (27) and a recovered hexane vapor stream by means of distillation. The recovered hexane vapor stream is condensed and a water-hexane stream, i.e. the first recovered solvent stream (28), and an non-condensable effluent gas stream (34) is obtained.

Step iv); Solvent was recovered from the effluent gas stream from step i) (29), from step ii) (33), and from step (iii) (34) in a solvent absorption system (10).
Step b): For solvent recovery, the effluent gas streams were brought into contact with an absorber oil in an absorption column (11) at a temperature of about 25 to 30° C.
In a comparative example (example not according to the invention), the absorber oil is a mineral oil (Parafluid PL501B from PARAFLUID GmbH).
In the example according to the invention, the absorber oil is MCT oil (RADIAMULS MCT 2107K from Oleon, which is a mixture of triglycerides with mainly C8 and C10 fatty acids).
As a result, an exit gas (13) was obtained and a solvent-rich absorber oil (15) (i.e. a solvent-rich mineral oil in case of the comparative example and a solvent-rich MCT oil in case of the example according to the invention).
Step c): The solvent absorbed by the absorber oil was removed from the solvent-rich absorber oil in a stripping column (16) at a temperature of the absorber oil in a range of from 90 to 130° C., from 100 to 125° C., or from 110 to 120° C. Steam was used as stripping agent (18). A recovered hexane stream (17) was obtained and a solvent-lean absorber oil (14) (i.e. a solvent-lean mineral oil in case of the comparative example and a solvent-lean MCT oil in case of the example according to the invention).
Step d): the solvent-lean absorber oil (14) was reused in step a) over a period of 1.5 months.

Step v): The hexane that was recovered from step iv) was reused over a period of 1.5 months in step i) for the extraction of oil from partially de-oiled sunflower cake (22).

### Analysis of MOSH and MOAH in the Sunflower Oil

Method DIN EN 16995:2017 (as part of CEN/TC275/WG 13) is the method that was used to measure the content of MOSH. The “content of MOSH” is defined as the total amount of saturated hydrocarbons (MOSH) with a carbon chain length in a range of C10 to C50.

### Results

Performance of MCT as absorber oil in the example according to the invention was evaluated and compared to mineral oil in the comparative example.

| | | Example |
|---|---|---|
| | Comparative | according to |
| | example | the invention |
| Amount of hexane absorbed in absorber | 2.31% | 2.35% |
| oil after step b) | | |
| Amount of hexane in exit gas after step b) | 1.7% LEL* | 1.7% LEL* |
| Amount of hexane retained in the | 0.22% | 0.20% |
| absorber oil after step c) | | |

*LEL: “Lower Explosive Limit” is defined as the lowest concentration (by percentage) of a gas or vapor in air that is capable of producing a flash of fire in presence of an ignition source (arc, flame, heat, etc.).

In terms of processability, MCT oil showed similar process performance as mineral oil. Compared to mineral oil, MCT oil resulted in:
similar efficiency of hexane recovery,
no indication of fouling of absorption column (step b)) or stripping column (step c)),
no indication of polymerization,
similar consumption of absorption oil over time,
similar consumption of hexane over time,
similar discoloration of the absorption oil over time.

The solvent extraction process wherein MCT oil was used as absorber oil (example according to the invention) resulted in a lower MOSH content of the obtained solvent extracted sunflower oil.

| | | | Example |
|---|---|---|---|
| | | Comparative | according to |
| | | example | the invention |
| Solvent extracted sunflower oil: | MOSH | 22.4 ppm | 4.3 ppm |

1. A method for recovering solvent from an effluent gas, wherein the method comprises the steps of:
a) providing an effluent gas from a solvent extraction system wherein oil is extracted from oil-containing organic material;
b) absorbing solvent from the effluent gas using a medium-chain triglyceride (MCT) oil to absorb the solvent;
c) stripping solvent from the MCT oil from step b); and
d) reuse of the recovered MCT oil from step c) for absorbing solvent, and
wherein the MCT oil has a combined content of fatty acid moiety having a chain length of C8 and C10 in a range of more than 92 wt. %.

2. The method according to claim 1, wherein the reuse of step d) is a recycle into step b).

3. The method according to claim 1, wherein the solvent extraction system comprises an extractor unit and the effluent gas in step a) is provided from the extractor unit.

4. The method according to claim 1, wherein the solvent extraction system comprises a desolventiser unit and the effluent gas in step a) is provided from the desolventizing unit.

5. The method according to claim 1, wherein the effluent gas in step a) has a solvent concentration in a range of from 50 to 70% by weight.

6. The method according to claim 1, wherein the MCT oil has a content of free fatty acids of less than 1%.

7. The method according to claim 1, wherein the MCT oil is provided to step b) at a temperature in a range of from 15 to 35° C.

8. The method according to claim 1, wherein the effluent gas is provided to step a) at a temperature of from 15 to 35° C.

9. The method according to claim 1, wherein the absorption occurs by counter-currently contacting the effluent gas and the MCT oil.

10. A process for extracting oil from oil-containing organic material by means of solvent, and the process comprises the steps of:
i) extracting oil-containing organic material with solvent and obtaining a miscella stream, a stream of solvent-wet residual solids, and a first effluent gas stream;
ii) recovering solvent from the solvent-wet residual solids stream from step i) and obtaining a second recovered solvent stream, a desolventized residual solids stream and a second effluent gas stream;
iii) separating the miscella stream from step i) into a first recovered solvent stream, extracted oil and a third effluent gas stream;
iv) recovering solvent from an effluent gas stream comprising the first effluent gas stream from step i), the second effluent gas stream from step ii), the third effluent gas stream from step iii), or a combination of two or more thereof, wherein the solvent recovering step iv) is comprising the method according to any one of claims 1 to 9, and obtaining a third recovered solvent steam and an exit gas; and
v) reuse of a recovered solvent stream comprising the first recovered solvent stream from step i), the second recovered solvent stream from step ii) and/or the third recovered solvent stream from step iv) for extraction of oil from oil-containing organic material.

11. The method according to claim 10, wherein the reuse of step v) is a recycle into step i).

12. The method according to claim 1, wherein solvent is hexane.

13. The use of MCT oil as absorber oil for recovering solvent from an effluent gas, wherein the solvent comprises hexane, and wherein the MCT oil has a combined content of fatty acid moiety having a chain length of C8 and C10 in a range of more than 92 wt. %.

14. The use according to claim 13 wherein the effluent gas is from a solvent extraction system and wherein the oil is extracted from oil-containing organic material.

15. The method according to according to claim 10, wherein solvent is hexane.
